(19) United States
(12) Patent Application Publication
(10) Pub. No.: US 2020/0401511 A1
(43) Pub. Date: Dec. 24, 2020

(54) ATTACHABLE PROTECTIVE DATA STORAGE DEVICE

(71) Applicant: Byrdbyte Creations Inc., Middletown, DE (US)

(72) Inventors: Emil Fadi Kort, Washington, DC (US); Maximillan Kent Dykes, London (GB)

(73) Assignee: Byrdbyte Creations Inc., Middletown, DE (US)

(21) Appl. No.: 16/821,113

(22) Filed: Mar. 17, 2020

Related U.S. Application Data
(60) Provisional application No. 62/796,099, filed on Jan. 24, 2019.
(60) Provisional application No. 62/854,365, filed on May 30, 2019.

(51) Int. Cl. G06F 12/02; G06F 1/16

(52) U.S. Cl. CPC G06F 12/0246; G06F 1/1628; G06F 2212/2146; G06F 2212/2022; G06F 2212/161

(57) ABSTRACT

A molded reinforced polymer case, which houses an integrated solid-state data storage drive, which attaches to a laptop. The solid-state drive connects to the laptop drive through a connective data cable.

### CROSS-REFERENCE TO RELATED APPLICATIONS

This application claims the benefit of U.S. provisional patent application No. 62/796,099, filed on Jan. 24, 2019, which is incorporated by this reference herein.

### TECHNICAL FIELD

This disclosure relates to the technical field of data storage. More particularly, the disclosure relates to integrating external data storage with protection for laptops.

### BACKGROUND

External hard drives (e.g., solid-state drives) (or “drive” for short) currently depend on a means of connection with a laptop solely through a cable. This temporary fixture is prone to unwanted disconnections, which can damage data on the drive, and result in a loss of any work being completed via the hard drive during operation.

### SUMMARY

In one aspect, this disclosure overcomes the above disadvantage by providing a case for laptop where the case includes a drive, and allows for more robust cable routing and management between the drive and the laptop. In one embodiments, the case is constructed of an injection molded polymer, and is reinforced via an additionally integrated reinforcement, and utilizes snap fittings to procure the semi-permanent fitting, thus producing a protective effect for the contained laptop. The integrated drive is contained within a space generated between interior reinforcement and exterior polymer case, whilst access is available through a connective data port.

Accordingly, in one embodiment there is provide a protective hard-shell injection molded polymer laptop case with integrated solid-state drive data storage.

By integrating an external data storage drive within a shell, the invention provides a snap fit between the case and the laptop whilst simultaneously providing a protective enclosure for the featured storage drive, therefore significantly reducing the risk of detachment during use, resulting in a protection from physical damage for the contained laptop.

### BRIEF DESCRIPTION OF THE DRAWINGS

Some Embodiments of the Present Invention are Illustrated as an Example and are not Limited by Figures of the Accompanying Drawings, in which References May Indicate Similar Elements and in which:

FIG. 1 depicts an exploded perspective view of all elements of the present invention;

FIG. 2 is a bottom up view of the case (Element 1) of FIG. 1;

FIG. 3 is a side view of the cross section of the constructed invention;

FIG. 4 is a side view of the cross section of the Attachable Protective Data Storage Case highlighting the manner in which the internal reinforcement (Element 3) is attached to the case (Element 1) via fixtures (Element 4).

FIG. 5 is a cross sectional view highlighting the snap fit interaction between Attachable Protective Data Storage Case and the laptop.

FIG. 6 is a perspective view of the slot provided for access to the invention's data port.

### DETAILED DESCRIPTION OF THE INVENTION

Referring now to an embodiment, the embodiment is comprised of an external case 1, a data storage mount 2, internal reinforcement 3, and fixtures 4, as depicted in FIG. 1.

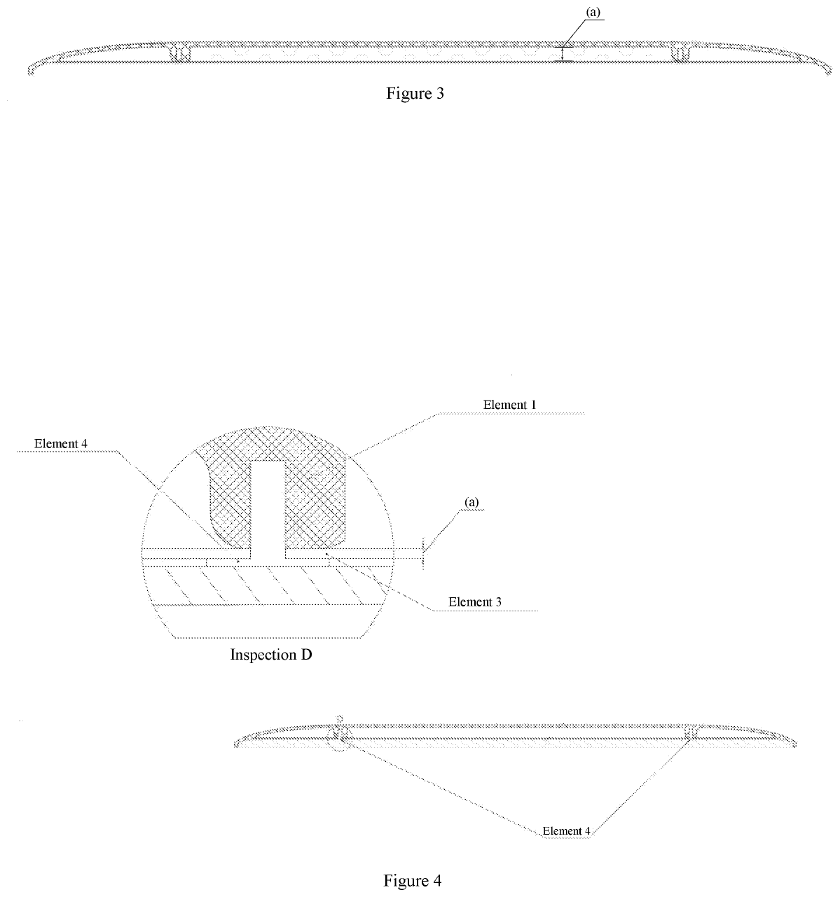

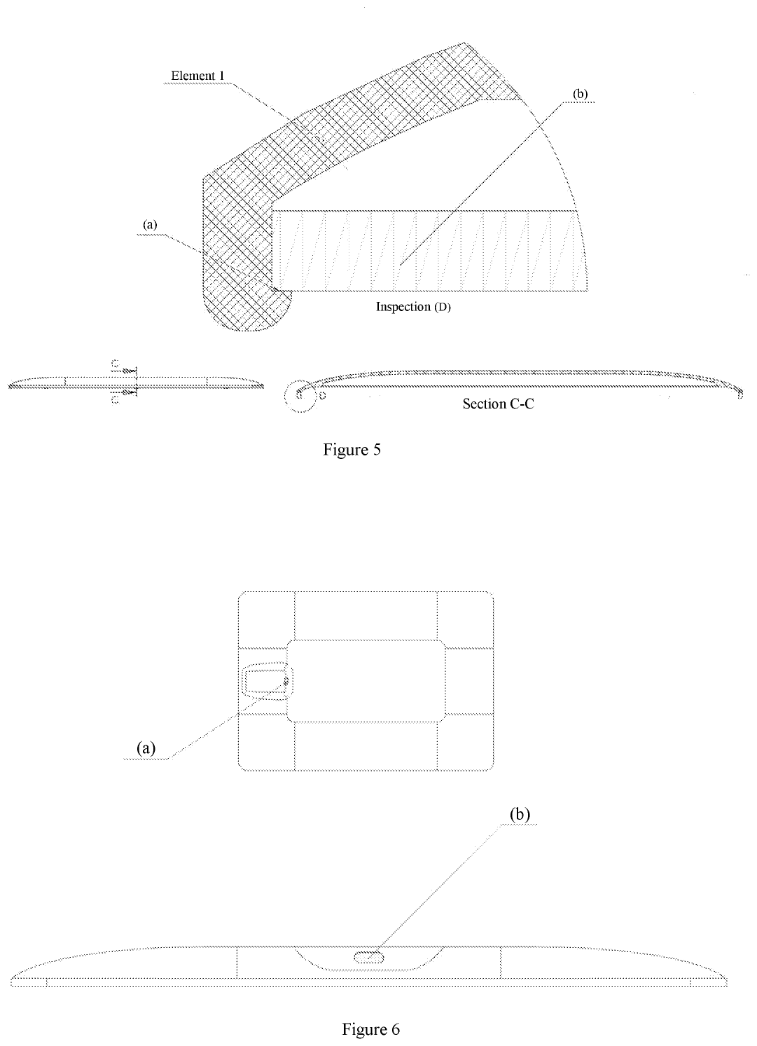

Elements 1 and 3 fit together to provide a space for the containment of an on-board storage, mounted via a printed circuit board 2, in the space (a) shown in FIG. 3 as hexagonal. These elements are secured in place by fixtures 4, which provides a buffer to fit a subsequent laptop. The resultant gap, denoted in FIG. 3 as (a) in the form of fatigue wear, prevents embedment of contaminants, e.g. grit, dust, dirt et al, into the main body of the laptop. The laptop is secured in place by integrated snap fittings, highlighted in FIG. 5 as D. Between the snap fittings integrated on the case 1 of FIG. 1, depicted in FIG. 5 as (a), and the fixtures between elements 1 and 3 provided by fixtures 4 as depicted in FIG. 3, a space is manifested that allows for the secure fit of a laptop whilst simultaneously producing a semi-permanent fixing for the storage drive, which is integrated by, and within, the assembled construct of the elements depicted in FIG. 1.

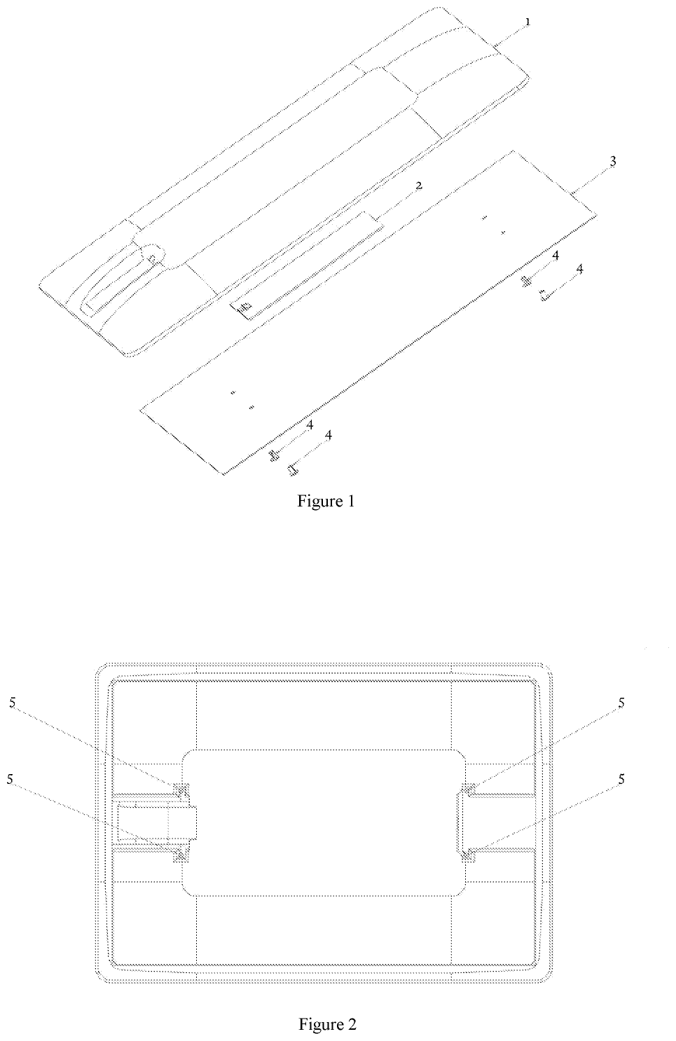

Referring now to FIG. 2, FIG. 2 shows a top down wireframe view of the case. Within FIG. 2, holes are denoted as element 5. The holes provide a space for the insertion of the fixtures in (FIG. 1, Element 4), that directly or indirectly, holds the internal reinforcement and subsequently the storage drive within the case. Secondly, as shown in FIG. 4, (Element 4) provides support that ensures an even pressure distribution in the high tolerance fitting of the laptop's distribution in the semi-permanent fitting between the laptop and the assembled elements of the invention, depicted in FIG. 1. Simultaneously, these ensure the laptop itself does not come into direct contact with the case's interior. Furthermore, the lower edge of (Element 1), the external case, features molded tabs. These tabs act as snap fittings, whereby a laptop can be semi-permanently attached and held within the case, as shown in FIG. 5. It is this attachment that serves a dual purpose—holding the data storage within and providing a hold between case and laptop.

The data connection between laptop and drive will be achieved through the use of an additional cable. This cable can be attached to the drive through a provided slot, highlighted in FIG. 6 as (a), which is designed to fit the female USB-C port.

The data storage drive will be mounted on the interior of the internal reinforcement respective to geometry that allows integration of the female USB-C directly into the slot featured on the external case as depicted in FIG. 6 as (b).

The advantages of the embodiments include, without limitation, the amalgamation of product and laptop, hence preserving the portability of personal computers whilst concurrently combining the convenience of external storage and physical protection for the laptop. Furthermore, the connection between storage drive and laptop is reliably secure as a result of the semi-permanent fixing between the laptop and the product. Connective data cables utilize the robust USB-C connection.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. An apparatus for use with a laptop, comprising:
a case for protecting the laptop, wherein the case is configured to attach to the laptop;
a solid-state drive data storage contained within the case; and
an electrical connector for connecting the solid-state drive to processing circuitry within the laptop.
